(19) United States
(12) Patent Application Publication
(10) Pub. No.: US 2016/0295373 A1
(43) Pub. Date: Oct. 6, 2016

(54) MOBILITY DETERMINATION USING LIKELIHOOD ESTIMATION

(71) Applicant: TEKTRONIX, INC., Beaverton, OR (US)

(72) Inventors: Shai Ronen, Pinole, CA (US); Geoff Hopcraft, Piedmont, CA (US); James Blondin, Oakland, CA (US)

(21) Appl. No.: 14/676,588

(22) Filed: Apr. 1, 2015

(51) Int. Cl. H04W 4/02

(52) U.S. Cl. CPC H04W 4/028

(57) ABSTRACT

A method for determining a mobility state of a mobile device is provided. A first estimated location of the mobile device is determined based on a first predictor set by generating a first location probability distribution associated with the first predictor set. A second estimated location of the mobile device is determined based on a second predictor set by generating a second location probability distribution associated with the second predictor set. A third estimated location of the mobile device is determined based on the first and second predictor sets and based on a combined first location probability distribution and second location probability distribution. A consistency analysis of the calculated first, second and third estimated locations is performed for the first and second predictor sets to determine the mobility state of the mobile device.

### FIELD OF THE INVENTION

The present invention elates to a mobility tracking method and, more particularly, elates to mobility determination based on likelihood estimation data.

### BACKGROUND OF THE INVENTION

A mobile device in a wireless communication system is very often in motion. The motion of the mobile device introduces variations into a communication channel between the mobile device and the base station. Currently in the art, there are a number of different ways to geolocate a mobile device. For instance, conventional technologies often use a Global Positioning System (GPS) device to determine the positions (location data) of mobile communication devices thereafter transmitting the locations data, preferably via a wireless network, to targeted businesses. While this approach may give relatively accurate information for a small number of devices, any attempt to gather positioning information from a large number of devices may consume large amounts of scarce bandwidth from the wireless network. Further, GPS data may not be available in locations where location based services may be used extensively, such as urban cities where high elevation buildings block access to a clear sky.

In addition, providers of wireless communication services have installed mobile device location capabilities into their networks. In operation, these network overlay location systems take measurements on radio frequency (“RF”) transmissions from mobile devices at base station locations surrounding the mobile device and estimate the location of the mobile device with respect to the base stations using well-known triangulation methods. Because the geographic location of the base stations is known, the determination of the location of the mobile device with respect to the base station permits the geographic location of the mobile device to be determined.

Heterogeneous networks include macro cells and small cells underlaid with respect to the macro cells. In a heterogeneous network, each small cell may vary in size with respect to the macro cells and other small cells. Further, small cells underlaid in the same macro cell may substantially overlap one another, for example, in high traffic areas within the coverage area of the macro cell. Accordingly, the spacing and sizing of cells in heterogeneous networks may be less uniform than the spacing and sizing of cells in a homogenous network. Consequently, the accuracy of the mobility state estimation provided by the method of counting cells may be reduced for heterogeneous networks, with respect to homogenous networks.

Accordingly, it may be desirable to use a mobility state estimation method which is effective and highly accurate for various types of networks and avoids the problems discussed above.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with a purpose of the illustrated embodiments, in one aspect, a method for determining a mobility state of a mobile device is provided. A first estimated location of the mobile device is determined based on a first predictor set by generating a first location probability distribution associated with the first predictor set. A second estimated location of the mobile device is determined based on a second predictor set by generating a second location probability distribution associated with the second predictor set. A third estimated location of the mobile device is determined based on the first and second predictor sets and based on a combined first location probability distribution and second location probability distribution. A consistency analysis of the calculated first, second and third estimated locations is performed to determine the mobility state of the mobile device.

### BRIEF DESCRIPTION OF THE DRAWINGS

The accompanying appendices and/or drawings illustrate various, non-limiting, examples, inventive aspects in accordance with the present disclosure:

FIG. 1 illustrates an exemplary wireless communication system in which illustrated embodiments of the present invention may be implemented;

FIG. 2 is a diagram for illustrating estimation of a mobile device's first location based on a first predictor set, in accordance with an embodiment of the present invention;

FIG. 3 is a diagram for illustrating estimation of a mobile device's second location based on a second predictor set, in accordance with an embodiment of the present invention;

FIG. 4 is a diagram for illustrating estimation of a mobile device's third location based on the first and second predictor sets, in accordance with an embodiment of the present invention;

FIG. 5 is a flowchart of operational steps of a location engine used in the wireless communication system of FIG. 1 in accordance with illustrative embodiments of the present invention; and

FIG. 6 illustrates internal and external components of a geolocation server computer of FIG. 1 in accordance with an illustrative embodiment of the present invention.

### DETAILED DESCRIPTION OF CERTAIN EMBODIMENTS

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described below.

The term “geolocation”, as used herein, refers to a geographic location of a mobile device as well as geographic location of a communication event observed by user equipment. The term “communication event”, as used herein, refers to any incoming or outgoing communication to or from a mobile device. Communication events include mobile station attachment, detachment, handover procedures, telephone calls, both sent and received, SMS messages both sent and received, e-mail correspondences both sent and received, and wireless application protocol sessions, among other data based transactions. Each communication event has at least two parties, the user of the mobile device and at least one correspondent element. The terms “mobile device” and “mobile station” may be used interchangeably herein. As used herein, movement of a mobile device includes movement of a car carrying the mobile device. The term “likelihood” may refer to a probability or chance of an event occurring, and may be expressed as a probability value, fraction, or percentage. The term “likelihood” as used herein may include the concept of a “probability” as used in mathematics and by persons of ordinary skill in the arts of statistical analysis.

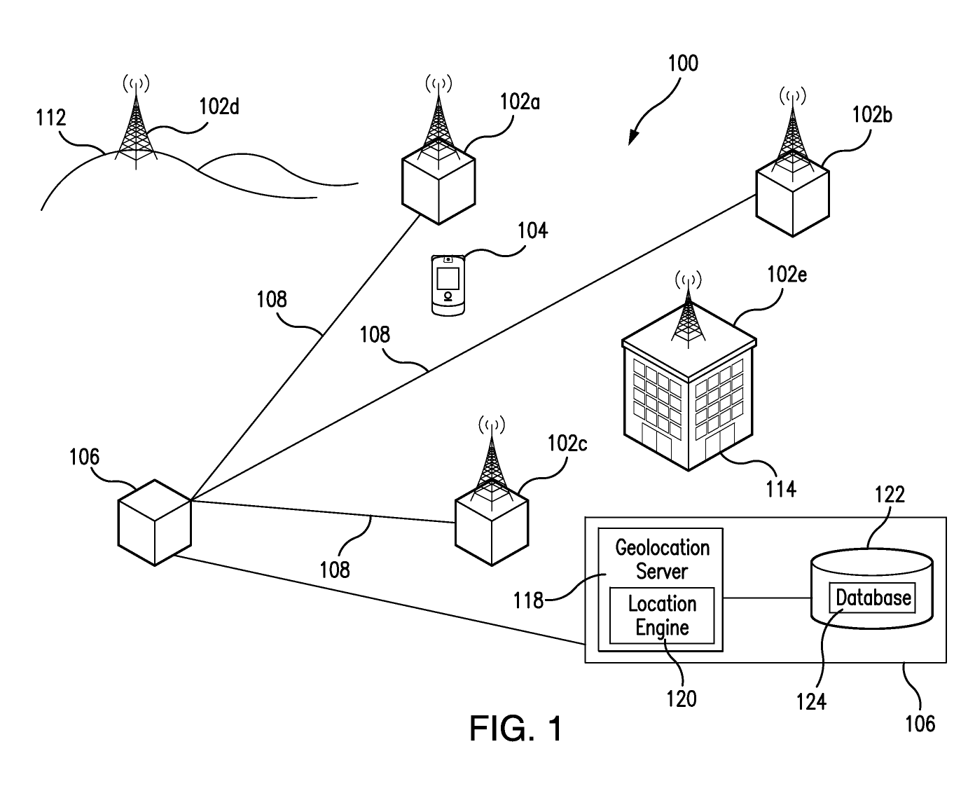

Turning now descriptively to the drawings, in which similar reference characters denote similar elements throughout the several views, FIG. 1 depicts an exemplary wireless communication system in which illustrated embodiments of the present invention may be implemented.

FIG. 1 shows a conventional wireless communication system 100 having a plurality of base stations 102a-e for communicating with a mobile device 104. Each base station 102a-e contains signal processing equipment and an antenna for transmitting to and receiving signals from the mobile device 104 as well as other base stations 102a-e.

A Mobile Switching Center (“MSC”) 106 typically is connected to each base station 102a-e through wireline connection 108. The MSC 106 may include a geolocation server 118. In the normal course of operation, the geolocation server 118 is tasked to determine the geolocation of a particular mobile device. The tasking is accomplished by retrieving previously collected and accumulated information on the mobile device of interest. In one embodiment such information is collected by the plurality of base stations 102a-e. The geolocation server 118 then employs the retrieved information to determine a mobility state of the mobile device of interest by running a location engine 120, as described below.

The base stations 102a-e may be configured to make measurements and collect a variety of wireless network data. The data collected by the base stations 102a-e may include, for each signal detected, the signal source's identification information, such as a IMSI (International mobile Subscriber Identity), MSISDN, MAC (Media Access Control) or EUI (Extended Unique Identifier) identifier or the signal's frequency; the signal's average signal strength; the standard deviation of its signal strength; and its yield, which is a measure of how often the signal is detected over a given time period. When monitoring, the base station 102a-e may collect a plurality of samples, or “polls”, of the detectable signals.

In addition to collecting signal-related information, the base stations 102a-e may collect a plurality of control parameters. For example, when the mobile device 104 initiates or receives a call or text message, radio communication takes place between the device and a base station, for example, base station 102a. In addition to transmitting an encoding of the message passing between caller and call recipient, the mobile device 104 and the base station 102a transmit a large amount of control information between themselves for the purposes of reliably and efficiently supporting the call and passing it between base stations 102a-e as the user operating mobile device 104 moves about. This control information may contain information on the signal strength of neighboring base stations, network's propagation path time measurements (e.g., timing advance information, propagation delay), transmission error rates and much more. Collectively these parameters are referred to herein as the “control parameters”. From this information, the geolocation server 118 obtains wireless network data related to the geolocation of the mobile device 104, as described below.

It is noted that the mobile device 104 is depicted in FIG. 1 as a mobile wireless device such as a cell phone or smart phone. However, it may be any portable device, such as a laptop, notebook, tablet computer, palm-sized computer, or any electronic device with capability to receive telecommunication (i.e. wireless) signals.

Location engine 120 comprises program instructions stored on one or more computer-readable storage devices, which may include internal storage on the geolocation server 118. Location engine 120 may be, for example, a computer program or program component for determining accurate location information by using probabilistic techniques, such as likelihood estimation, based on accumulated network data. Data gathered, generated, and maintained for use by the location engine 120 may be kept in the internal storage of the geolocation server 118 or in one or more databases 124 of a storage unit 122 contained within the MSC 106.

The wireless communication system 100 shown in FIG. 1 may comprise a radio access network (RAN). For purposes of the present patent application, the RAN may be implemented in any combination of known or heretofore unknown radio access technology and network protocols. For instance, the RAN may comprise a combination of UMTS Terrestrial Radio Access Network (UTRAN), Wireless Local Area Network (WLAN), Digital Enhanced Cordless Technology (DECT), GSM EDGE Radio Access Network (GERAN), Worldwide Interoperability for Microwave Access (WiMAX) network, Device to Device (D-D), etc. The RAN can also be an aggregation of channels from multiple bands in the radio access technology LTE-A (Long Term Evolution—Advanced). LTE-A is a set of enhancements to the UMTS that includes an all-IP networking architecture and the ability of each base station to connect to multiple core networks.

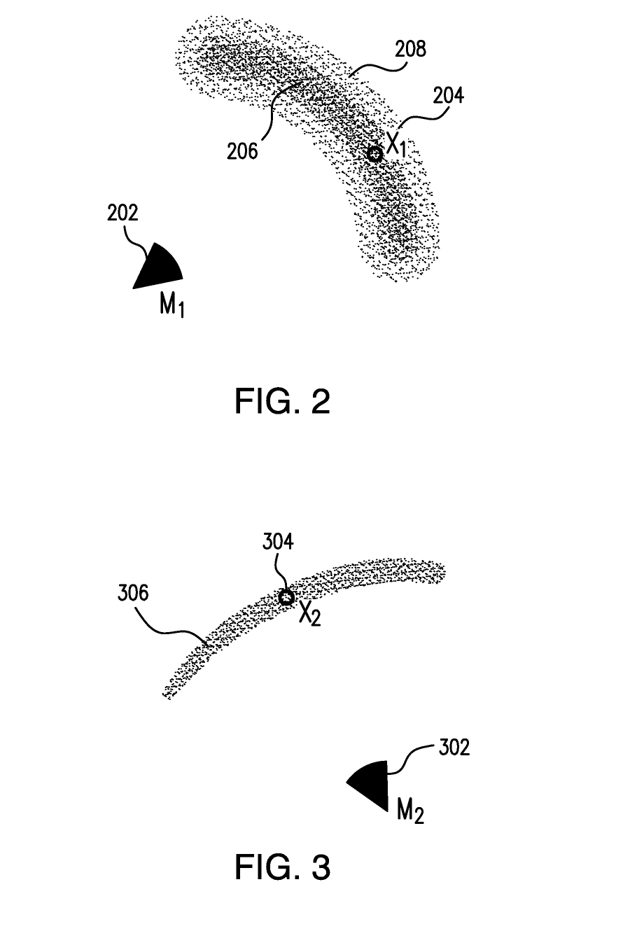

According to an embodiment of the present invention, a location of a mobile device is determinable by the relationship of various items of accumulated network data. FIG. 2 is a simplified diagram for illustrating location estimation for such a device. As previously indicated, in one aspect of a wireless communication network 100, data may be requested and exchanged among entities operating in the network 100. For example, location engine 120 may receive data from wireless communication network 100 to determine the position of mobile device 104 operating within network 100. However, these are merely examples of data exchange between location engine 120 and wireless network 100 in a particular aspect, and claimed subject matter in not limited in these respects. For purposes of illustration, assume that one or more base stations 102a-e servicing mobile device 104 detect and capture a communication event associated with mobile device 104 at time t₁ and MSC 106 collects all wireless network data associated with such communication event. In the preferred embodiment of the present invention, the desired network traffic data may include control-plane data, such as, for instance, information relating to at least a plurality of signal strength measurements, a plurality of propagation path time measurements and information relating to transmission error rates associated with the mobile device 104, and the like. More specifically, wireless communication system 100 may continuously track and capture various network traffic data measurements, including control-plane data. Each of the desired network traffic data items may help reflect a specific aspect of mobility behavior of the subscribers (persons carrying mobile device 104). Accordingly, once geolocation server 118 obtains additional network data, location engine 120 preferably determines whether this newly obtained data can be used to establish and/or improve understanding of the mobile device's 104 geolocation.

A first predictor set M₁ 202 depicted in FIG. 2 comprises a network dataset including wireless network data relating to the first communication event that occurred at time t₁, which may be fetched by location engine 120 from geolocation server 118. According to an embodiment of the present invention, location engine 120 may determine a first estimated location X₁ 204 at time t₁ based on the first predictor set M₁ 202. In one particular implementation, first estimated location 204 may include a location fix of mobile device 104. A location fix may provide geographic information, such as latitude and longitude and/or any information that may convey a location and/or position of mobile device 104. A location fix may include relative location information, wherein a location is provided in terms relative to another location, such as a location of a cellular tower, a second mobile station, and a previous location fix, just to name a few examples.

Rather than just estimating a single location X₁ 204 at time t₁, it is possible to generate a probability distribution of estimated locations based on an uncertainty or error distribution of the location of mobile device 104 at time t₁. The probability distribution can include a variety of possible locations of mobile device 104. In other words, the probability distributions indicate how likely it is that mobile device 104 was present at each identified location for a particular time slot t₁. In FIG. 2, a first (darker) region 206 represents more likely locations of mobile device 104, while a second (lighter) region 208 represents less likely locations of mobile device 104. In this illustrative case, first estimated location X₁ 204 represents the most probable location given first predictor set M₁ 202 at time t₁, as calculated by location engine 120. In other words, location engine 120 may be configured to calculate first estimated location X₁ 204 based on the information contained in first predictor set M₁ 202. It is noted that the likelihood that first estimated location X₁ 204 is correct may be represented as [symbol] _{1|1}. An exemplary expression for a first location probability distribution associated with the first predictor set M₁ 202 is given below as expression (1):

[symbol]

_{1|1}= [symbol] (X₁|M₁) (1)

FIG. 3 is a diagram for illustrating estimation of a mobile device's second location based on a second predictor set, in accordance with an embodiment of the present invention. Once again for purposes of illustration, assume that one or more base stations 102a-e servicing mobile device 104 detect and capture a communication event associated with mobile device 104 at a later time t₂ and MSC 106 collects all wireless network data associated with such communication event. A second predictor set M₂ 302 depicted in FIG. 3 comprises this second network dataset including wireless network data relating to the second communication event.

According to an embodiment of the present invention, location engine 120 may generate a second location probability distribution 306 of possible locations of mobile device 104 at time t₂ based on the second predictor set M₂ 302. In this illustrative case, second estimated location X₂ 304 depicted in FIG. 3 represents the most probable location given second predictor set M₂ 302 at time t₂, as calculated by location engine 120. In other words, location engine 120 may be further configured to calculate second estimated location X₂ 304 based on the information contained in second predictor set M₂ 302. It is noted that the likelihood that second estimated location X₂ 304 is correct may be represented as [symbol] _{2|2}. An exemplary expression for a second probability distribution associated with the second predictor set M₂ 302 is given below as expression (2):

[symbol]

_{2|2}= [symbol] (X₂|M₂) (2)

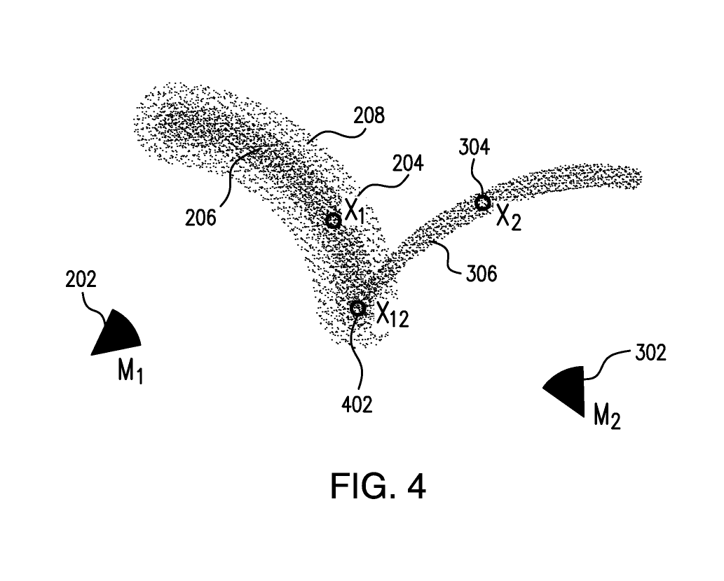

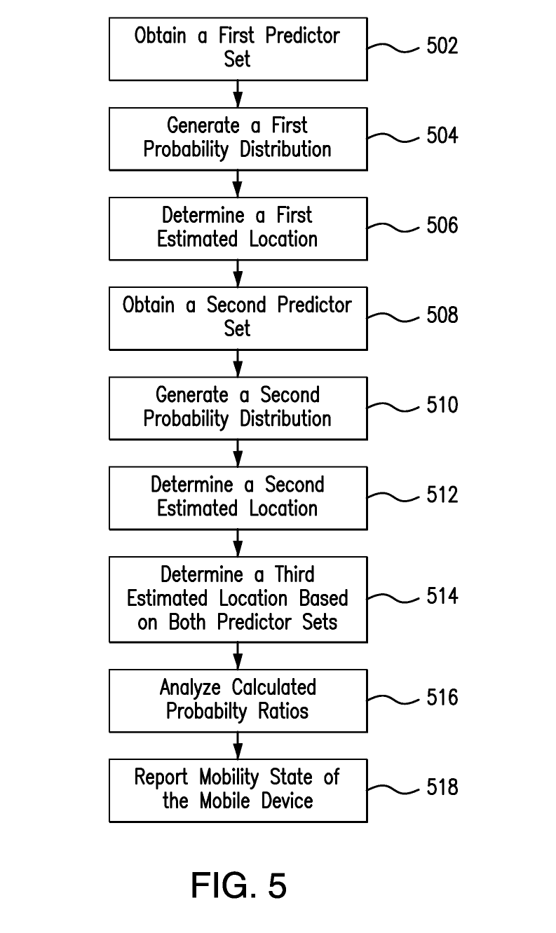

According to an embodiment of the present invention, next step of the method performed by location engine 120 and described below in conjunction with FIG. 5, may include calculating a third estimated location by combining previously generated results. FIG. 4 is a diagram for illustrating estimation of a mobile device's third location based on the first and second predictor sets, in accordance with an embodiment of the present invention. As shown in FIG. 4, in this calculation step location engine 120 incorporates both first predictor set M₁ 202 and second predictor set M₂ 302. Furthermore, location engine 120 may also utilize the first probability distribution 206 representing more likely locations of mobile device 104 at time t₁ and second probability distribution 306 representing more likely locations of mobile device 104 at time t₂.

Accordingly, location engine 120 may be further configured to calculate third estimated location X₁₂ 402 based on the information contained in both first predictor set M₁ 202 and second predictor set M₂ 302. It is noted that the likelihood that third estimated location X₁₂ 402 is correct may be represented as [symbol] _{12|12}. According to an embodiment of the present invention, location engine 120 may determine third estimated location X₁₂ without considering the time interval Δt₁₂ representing a difference between corresponding time instances t₁ and t₂. An exemplary expression for a probability distribution associated with the combined first predictor set M₁ 202 and second predictor set M₂ 302 is given below as expression (3):

[symbol]

_{12|12}= [symbol] (X₁₂|M₁∪M₂) (3)

In summary, FIGS. 2-4 illustrate estimation of a mobile device's first, second and third locations based on the first, second and combination of the first and second predictor sets, respectively, in accordance with an embodiment of the present invention. These illustrations correspond to steps 504-514 of FIG. 5 described in more details below.

FIG. 5 is a flowchart of operational steps of a location engine used in the wireless communication system of FIG. 1 in accordance with illustrative embodiments of the present invention. Before turning to description of FIG. 5, it is noted that the flow diagram in FIG. 5 shows example in which operational steps are carried out in a particular order, as indicated by the lines connecting the blocks, but the various steps shown in this diagram can be performed in any order, or in any combination or sub-combination. It should be appreciated that in some embodiments some of the steps described below may be combined into a single step. In some embodiments, one or more steps may be omitted. In some embodiments, one or more additional steps may be performed.

According to an embodiment of the present invention, location engine 120 determines a substantially accurate mobility state of a mobile device based on a statistical likelihood estimation of possible mobile device locations. For instance, if the detected signal power measurements associated with a mobile device change over a relatively short period of time, it can be determined whether these changes are attributed to a movement of the mobile device. Thus, at 502, location engine 120 may retrieve a first predictor set. In an embodiment of the present invention the first predictor set may comprise network traffic data associated with the mobile device of interest. The network traffic data can be generated by different components of the wireless network system, such as base stations 102a-e depicted in FIG. 1.

In the preferred embodiment of the present invention, the desired network traffic data may include control-plane data, such as, for instance, historical timing advance information, power information indicating a detected power of respective signals received from mobile device 104, corresponding base station location information; handover information, which may be directional handover or handover due to a specific cause (e.g., power budget handover), and the like. Each of the desired network traffic data items may help reflect a specific aspect of mobility behavior of the subscribers associated with the mobile device 104. As data is captured by a plurality of base stations 102a-e, such data can be associated with time-stamps. For instance, if mobile device 104 initiates a communication event at time t₁, the first predictor set corresponding to such call may be associated with this time instance. It is noted that the first predictor set may include measurements captured by different components (e.g., different base stations) within wireless network 100. In a preferred embodiment, location engine 120 may receive first predictor set as network data mapped into the time domain and spatial domain.

At 504, location engine 120 may process both the time domain and spatial domain data to generate a first location probability distribution associated with the first predictor set. When location engine 120 has processed the time series of network data measurements included in the first predictor set M₁ 202, it will have calculated the probability that the mobile device 104 is at each point of possible geolocations. This probability distribution incorporates all of the information that has been collected on the mobile device 104 as part of the first predictor set M₁ 202. As depicted in FIG. 2, in one embodiment, the first probability distribution may include a first region 206 representing more likely locations of mobile device 104 and a second region 208 representing less likely locations of mobile device 104.

At 506, location engine 120 may use the generated first location probability distribution to compute a first estimate of the mobile device's 104 location. In a preferred embodiment, location engine 120 calculates both the expected location and the most probable location, but other location statistics (as deemed appropriate) could also be calculated from the generated first location probability distribution. In various embodiments, the first location estimate may be calculated for either the time of the last measurement in the first predictor set 202 (which yields a filtered estimate) or for some time before the last network data measurement in the first predictor set 202 (which yields a smoothed estimate). The smoothed estimate is more accurate than the filtered estimate, because it uses more information (i.e., some number of subsequent measurements). However, the smoothed estimate requires both a larger first predictor set 202 and more computation than the filtered estimate. In one embodiment of the present invention, the first estimated location of mobile device 104 may be represented by the most probable location (i.e. location X₁ 204 depicted in FIG. 2) given first predictor set M₁ 202 at time t₁.

Next, according to an embodiment of the present invention, location engine 120 may calculate a second location probability distribution based on measurements contained in the second predictor set 302 alone. Accordingly, at 508, location engine 120 may obtain second predictor set M₂ 302 from geolocation server 118 and/or from MSC 106, for example. In one embodiment, second predictor set 302 may include one or more network data measurements (i.e., control plane data items discussed above) associated with another mobile device's 104 communication event that was observed by one or more components of the wireless network system 100 at a later time instance t₂. It is noted that network data contained within the second predictor set M₂ 302 may include measurements captured by the same components, different components or combination of components of the wireless network system 100. Again, in accordance with the preferred embodiment, location engine 120 may receive second predictor set 302 as network data mapped into the time and spatial domains.

At 510, location engine 120 may process both the time domain and spatial domain data to generate a second location probability distribution associated with the second predictor set 302. This probability distribution 306 incorporates all of the information that has been collected on the mobile device 104 as part of the second predictor set M₂ 302. At 512, the second location probability distribution is then used by location engine 120 to compute a second estimate of the current location of the mobile device 104 using one of several well-known statistical methods. Again, in accordance with the preferred embodiment, location engine 120 may calculate both the expected location and the most probable location, but other location statistics (as deemed appropriate) could also be calculated from the generated second location probability distribution. The second estimated location X₂ 304 depicted in FIG. 3 represents the most probable location given second predictor set M₂ 302 at time t₂.

Next step in determining a mobility state of mobile device 104, in accordance with an embodiment of the present invention, may include combining the information provided by first predictor set M₁ 202 and second predictor set M₂ 302 to determine a third estimated location. In other words, location engine 120 may be further configured to calculate, at step 514, third estimated location X₁₂ 402 (shown in FIG. 4) based on the information contained in both first and second predictor sets. It is noted that the likelihood that third estimated location X₁₂ 402 is correct may be represented as [symbol] _{12|12} defined as expression (3) above. At this point, location engine 120 has determined three calculated estimated location values based on two predictor sets M₁ 202 and M₂ 302. In the preferred embodiment, location engine 120 may validate such calculation results by performing a data consistency analysis for the calculated locations dependent on the various predictor sets.

Accordingly, at step 516, location engine 120 may calculate additional probabilities for third estimated location X₁₂ 402 by incorporating either the second predictor set M₂ 302 or the first predictor set M₁ 202 exclusively. These additional probabilities are denoted as [symbol] _{12|1} if only first predictor set M₁ 202 is included in calculating third estimated location X₁₂ 402 and as [symbol] _{12|2} if only second predictor set M₂ 302 is included in calculating third estimated location X₁₂ 402. Further, step 516 involves analyzing ratios of previously calculated location probabilities based on various predictor sets. In an embodiment of the present invention, location engine 120 may compare one or more ratios of calculated location probabilities to a threshold function ⊖(t) which depends on the elapsed time between the two predictor sets, according to the following expressions:

$$\begin{matrix}θ ( t ) < ln ( \frac{{ℒ}_{12 \vert 1}}{{ℒ}_{1 \vert 1}} ) \\ and & ( 4 ) \\ θ ( t ) < ln ( \frac{{ℒ}_{12 \vert 2}}{{ℒ}_{2 \vert 2}} ) , & ( 5 )\end{matrix}$$

Wherein ⊖(t) is a monotonous increasing function of time t. For example, this function may parameterized by (but not limited to) an expression:

$$θ ( t ) = - A + ( A + B ) * exp ( - \frac{t}{C} ) ,$$

where A,B,C represent judiciously chosen parameters, [symbol] _{12|1} represents probability for third estimated location X₁₂ 402 by incorporating only first predictor set M₁ 202, [symbol] _{12|2} represents probability for third estimated location X₁₂ 402 by incorporating only second predictor set M₂ 302, [symbol] _{1|1} represents the first probability distribution associated with the first predictor set calculated at step 504, and [symbol] _{2|2} represents the second probability distribution associated with the second predictor set calculated at step 510. In an embodiment of the present invention, the time dependent function ⊖(t) serves as a consistency threshold between the two compared predictor sets M₁ 202 and M₂ 302. It is noted that expressions (4) and (5) above can be combined and rewritten as the following expression:

$$θ ( t ) < ln ( \frac{{ℒ}_{xy \vert m}}{{ℒ}_{m \vert m}} ) \qquad ( 6 )$$

wherein the symbols xy represent a specific sample of third estimated location X₁₂ 402 and symbol m represents either one of the predictor sets M₁ 202 and M₂ 302 to be compared. It should be noted that expression (6) above denotes a mathematical expression for a consistent predictor or location comparison. In other words, if the expression (6) is evaluated as true, location engine 120 considers the previously calculated results to be consistent.

Vice versa, the following expression (7) denotes a mathematical expression for an inconsistent predictor or location comparison:

$$θ ( t ) > ln ( \frac{{ℒ}_{xy \vert m}}{{ℒ}_{m \vert m}} ) \qquad ( 7 )$$

Accordingly, location engine 120 may evaluate either the expression (6) or (7) for both predictor sets individually. While in some embodiments, location engine 120 may evaluate either the expression (6) or (7) just for one of the predictor sets, the corresponding results would be considered statistically less accurate. In case any of these comparisons indicate an inconsistent predictor, location engine 120 may designate the overall result of the consistency analysis to ‘inconsistent’.

The consistency statement enables location engine 120 to make the final mobility estimation decision. Non consistent locations typically indicate at least some mobility inbetween the measurement times. However, in order to get better mobility determination for the most recent event time, location engine 120 may define certain pre-chosen constant time intervals Δt_{mobile} and Δt_{stationary}, wherein the former is a relatively short time interval and the latter is a longer time interval. For illustrative purposes assume that Δtₘ represents the time interval from the reception of the last consistent predictor set to the most recent predictor set. If location engine 120 determines that both condition (7) is true and Δt_{m<}Δt_{mobile}, location engine 120 concludes that the user is in fact mobile during the time of the most recent measurement set. If both condition (7) is false and Δt_{m>}Δt_{stationary}, location engine 120 infers that the user is in fact stationary during the time of the most recent measurement. In any other case location engine 120 preferably reports the mobility status as yet unknown. Cases marked as unknown with respect to mobility may correspond, for example, to users making one call from home and another one from their office (but not during commute between home and office) or users making a short call from a car while waiting for a traffic signal. In other words, if the analyzed calls are too far apart to infer recent motion or if the duration of the analyzed calls is too short to attribute them as truly stationary, location engine 120 preferably reports the mobility status as yet unknown.

Hence, if location engine 120 determines that expression (7) evaluates to true and Δt_{m<}Δt_{mobile}, location engine 120 may conclude, with a high degree of accuracy, that current position of mobile device 104 is much different than the previously-calculated position fix indicating that mobile device 104 has moved from its previously calculated position.

Optionally, at step 518, location engine 120 may report the determined mobility state of mobile device 104. In one embodiment, location engine 120 may present the determined mobility state to a user such as a wireless network technician via a graphical user interface which may for example be executable from geolocation server 118.

Further, in accordance with the preferred embodiment, location engine 120 repeats steps 502-518 for each new successive predictor set received from geolocation server 118. It is noted that if at step 516 location engine 120 determines that mobile device 104 has moved, first predictor set M₁ 202 is no longer indicative of the current location and may be discarded from future calculations. On the other hand, if at step 516 location engine 120 determines that mobile device 104 is stationary, location engine 120 could improve the previously estimated location by this inherent nature of the consistency check. For instance, if persons carrying mobile device 104 initiated a few different calls from the same geolocation and location engine 120 receives a few predictor sets associated with each phone call, in response to determining that all of the received predictor sets are consistent, advantageously, location engine 120 may combine these predictor sets for further estimation improvement. Such estimation improvement may include, for instance, fetching new predictor dimensions, minimizing equidistant area of location probability, and the like.

In summary, various embodiments of the present invention advantageously contemplate analysis of the spatial location probability ratio rather than comparing location estimates themselves. Furthermore, the disclosed mobility determination approach using likelihood estimation enables utilization of multi-dimensional predictor set inputs for single locations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

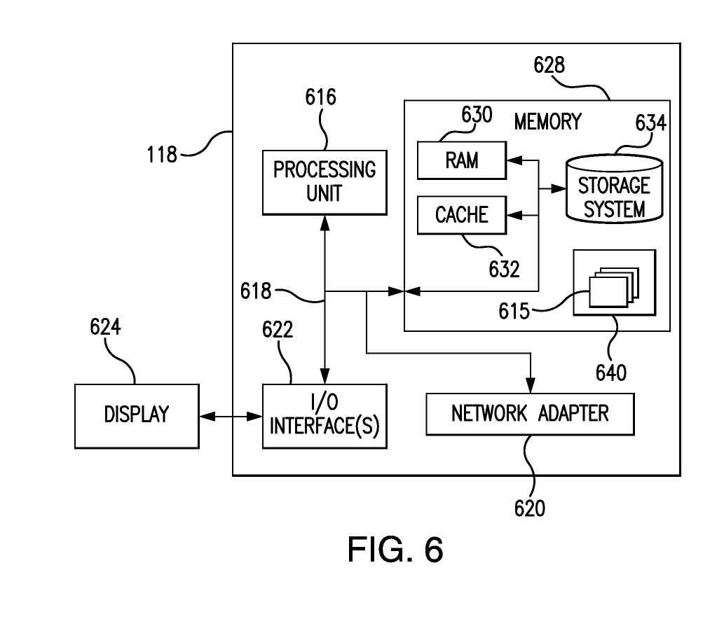

Embodiments of location engine 120 may be implemented or executed by one or more computer systems. One such computer system, geolocation server 118 is illustrated in FIG. 6. In various embodiments, geolocation server 118 may be a server, a mainframe computer system, a workstation, a network computer, a desktop computer, a laptop, or the like.

Geolocation server 118 is only one example of a suitable system and is not intended to suggest any limitation as to the scope of use or functionality of embodiments of the invention described herein. Regardless, geolocation server 118 is capable of being implemented and/or performing any of the functionality set forth hereinabove.

Geolocation server 118 is operational with numerous other general purpose or special purpose computing system environments or configurations. Examples of well-known computing systems, environments, and/or configurations that may be suitable for use with geolocation server 118 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices, and the like.

Geolocation server 118 may be described in the general context of computer system-executable instructions, such as program modules, being executed by a computer system. Generally, program modules may include routines, programs, objects, components, logic, data structures, and so on that perform particular tasks or implement particular abstract data types. Geolocation server 118 may be practiced in distributed data processing environments where tasks are performed by remote processing devices that are linked through a communications network. In a distributed data processing environment, program modules may be located in both local and remote computer system storage media including memory storage devices.

Geolocation server 118 is shown in FIG. 6 in the form of a general-purpose computing device. The components of geolocation server 118 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Geolocation server 118 typically includes a variety of computer system readable media. Such media may be any available media that is accessible by geolocation server 118, and it includes both volatile and non-volatile media, removable and non-removable media.

System memory 628 can include computer system readable media in the form of volatile memory, such as random access memory (RAM) 630 and/or cache memory 632. Geolocation server 118 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 615, such as location engine 120, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 615 generally carry out the functions and/or methodologies of embodiments of the invention as described herein.

Geolocation server 118 may also communicate with one or more external devices such as a keyboard, a pointing device, a display, etc.; one or more devices that enable a user to interact with geolocation server 118; and/or any devices (e.g., network card, modem, etc.) that enable geolocation server 118 to communicate with one or more other computing devices. Such communication can occur via Input/Output (I/O) interfaces 622. Still yet, geolocation server 118 can communicate with one or more networks such as a local area network (LAN), a general wide area network (WAN), and/or a public network (e.g., the Internet) via network adapter 620. As depicted, network adapter 620 communicates with the other components of geolocation server 118 via bus 618. It should be understood that although not shown, other hardware and/or software components could be used in conjunction with geolocation server 118. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for determining a mobility state of a mobile device, the method comprising the steps of:
determining, by a processor, a first estimated location of the mobile device based on a first predictor set by generating a first location probability distribution associated with the first predictor set;
determining, by a processor, a second estimated location of the mobile device based on a second predictor set by generating a second location probability distribution associated with the second predictor set;
determining, by a processor, a third estimated location of the mobile device based on the first and second predictor sets and based on a combined first location probability distribution and second location probability distribution; and
performing, by a processor, a consistency analysis of the calculated first, second and third estimated locations for the first and second predictor sets to determine the mobility state of the mobile device.

2. The method of claim 1, wherein the first and second predictor sets comprise wireless network data associated with the mobile device.

3. The method of claim 1, wherein the first predictor set is associated with a first time instance, the second predictor set is associated with a second time instance and wherein the second time instance is later than the first time instance.

4. The method of claim 1, wherein performing the consistency analysis comprises invoking a threshold function.

5. The method of claim 4, wherein performing the consistency analysis comprises:
determining, by a processor, a first ratio, the first ratio comprising a ratio of the combined first location probability distribution and second location probability distribution based on the first predictor set to the first location probability distribution;
determining, by a processor, a second ratio, the second ratio comprising a ratio of the combined first location probability distribution and second location probability distribution based on the second predictor set to the second location probability distribution; and
comparing, by a processor, the first ratio and the second ratio with the threshold function to determine the mobility state of the mobile device.

6. The method of claim 5, wherein the mobility state of the mobile device comprises a stationary state if the threshold function is less than the first ratio or if the threshold function is less than the second ratio.

7. The method of claim 2, wherein the wireless network data comprises information relating to at least a plurality of signal strength measurements, a plurality of propagation path time measurements and information relating to transmission error rates associated with the mobile device.

8. The method of claim 2, wherein the wireless network data is converted into a time domain data and a spatial domain data.

9. The method of claim 1, wherein the performed consistency analysis comprises a recursive analysis.

10. A computer program product for determining a mobility state of a mobile device, the computer program product comprising:
one or more computer-readable storage devices and a plurality of program instructions stored on at least one of the one or more computer-readable storage devices, the plurality of program instructions comprising:
program instructions to determine a first estimated location of the mobile device based on a first predictor set by generating a first location probability distribution associated with the first predictor set;
program instructions to determine a second estimated location of the mobile device based on a second predictor set by generating a second location probability distribution associated with the second predictor set;
program instructions to determine a third estimated location of the mobile device based on the first and second predictor sets and based on a combined first location probability distribution and second location probability distribution; and
program instructions to perform a consistency analysis of the calculated first, second and third estimated locations for the first and second predictor sets to determine the mobility state of the mobile device.

11. The computer program product of claim 10, wherein the first and second predictor sets comprise wireless network data associated with the mobile device.

12. The computer program product of claim 10, wherein the first predictor set is associated with a first time instance, the second predictor set is associated with a second time instance and wherein the second time instance is later than the first time instance.

13. The computer program product of claim 10, wherein the program instructions to perform the consistency analysis comprise program instructions to invoke a threshold function.

14. The computer program product of claim 13, wherein the program instructions to invoke a threshold function comprise:
program instructions to determine a first ratio, the first ratio comprising a ratio of the combined first location probability distribution and second location probability distribution based on the first predictor set to the first location probability distribution;
program instructions to determine a second ratio, the second ratio comprising a ratio of the combined first location probability distribution and second location probability distribution based on the second predictor set to the second location probability distribution; and
program instructions to compare the first ratio and the second ratio with the threshold function to determine the mobility state of the mobile device.

15. The computer program product of claim 14, wherein the mobility state of the mobile device comprises a stationary state if the threshold function is less than the first ratio or if the threshold function is less than the second ratio.

16. The computer program product of claim 11, wherein the wireless network data comprises information relating to at least a plurality of signal strength measurements, a plurality of propagation path time measurements and information relating to transmission error rates associated with the mobile device.

17. The computer program product of claim 11, wherein the wireless network data is converted into a time domain data and a spatial domain data.

18. The computer program product of claim 10, wherein the program instructions to perform a consistency analysis comprise program instructions to perform a recursive analysis.

19. A computer system for determining a mobility state of a mobile device, the computer system comprising one or more processors, one or more computer-readable storage devices, and a plurality of program instructions stored on at least one of the one or more storage devices for execution by at least one of the one or more processors, the plurality of program instructions comprising:
program instructions to determine a first estimated location of the mobile device based on a first predictor set by generating a first location probability distribution associated with the first predictor set;
program instructions to determine a second estimated location of the mobile device based on a second predictor set by generating a second location probability distribution associated with the second predictor set;
program instructions to determine a third estimated location of the mobile device based on the first and second predictor sets and based on a combined first location probability distribution and second location probability distribution; and
program instructions to perform a consistency analysis of the calculated first, second and third estimated locations for the first and second predictor sets to determine the mobility state of the mobile device.

20. The computer system of claim 19, wherein the first and second predictor sets comprise wireless network data associated with the mobile device.
